(19) United States
(12) Patent Application Publication
(10) Pub. No.: US 2025/0139593 A1
(43) Pub. Date: May 1, 2025

(54) ELECTRONIC APPARATUS

(71) Applicant: SEIKO EPSON CORPORATION, Tokyo (JP)

(72) Inventors: Masanori KOIZUMI, Suwa (JP); Daisuke KURITA, Shiojiri (JP)

(21) Appl. No.: 18/928,252

(22) Filed: Oct. 28, 2024

(30) Foreign Application Priority Data
Oct. 30, 2023 (JP) 2023-185299

(51) Int. Cl. G06Q 10/30; G06Q 10/0631

(52) U.S. Cl. CPC G06Q 10/30; G06Q 10/06312

(57) ABSTRACT

An electronic apparatus including a replaceable specific component, includes an acquisition unit acquiring reuse information related to a reuse history of the specific component, a generation unit generating reuse schedule information indicating a future reuse mode of the specific component based on the reuse information, and a display control unit controlling a display unit to display the future reuse mode of the specific component based on the reuse schedule information.

The present application is based on, and claims priority from JP Application Serial Number 2023-185299, filed Oct. 30, 2023, the disclosure of which is hereby incorporated by reference herein in its entirety.

### BACKGROUND

### 1. Technical Field

The present disclosure relates to an electronic apparatus.

### 2. Related Art

In related art, as disclosed in JP-A-2016-224273, in an electronic apparatus including a replaceable specific component such as a toner container, a technology of storing, when a used specific component is reused, a reuse count of the specific component is known.

JP-A-2016-224273 is an example of the related art.

However, in the related art, a user of the electronic apparatus is not able to grasp whether the specific component is reusable in the future. Accordingly, in the related art, the motivation for the user of the electronic apparatus to reuse the specific component may be insufficient, and has room for improvement, of the SDGs, namely, the 17 sustainable development goals adopted in the United Nations General Assembly on Sep. 25, 2015, on Goal 13 “take urgent action to combat climate change and its impacts”, for example.

### SUMMARY

According to an aspect of the present disclosure, an electronic apparatus including a replaceable specific component includes an acquisition unit acquiring reuse information related to a reuse history of the specific component, a generation unit g reuse schedule information indicating a future reuse mode of the specific component based on the reuse information, and a display control unit controlling a display unit to display the future reuse mode of the specific component based on the reuse schedule information.

### BRIEF DESCRIPTION OF THE DRAWINGS

FIG. 1 is a block diagram showing an example of a configuration of a management system Sys according to an embodiment of the present disclosure.

FIG. 2 is a block diagram showing an example of a configuration of a cartridge 7.

FIG. 3 is a block diagram showing an example of a configuration of a user card 8.

FIG. 4 is a block diagram showing an example of a configuration of a recycling box 3.

FIG. 5 is a block diagram showing an example of a configuration of a management server 1.

FIG. 6 is a block diagram showing an example of a configuration of a printing apparatus 5.

FIG. 7 is a data configuration diagram showing an example of a data configuration of message template information DM.

FIG. 8 is a block diagram showing an example of a configuration of a terminal apparatus 6.

FIG. 9 is a flowchart showing an example of an operation of the printing apparatus 5 when reuse schedule presentation processing is executed.

### DESCRIPTION OF EMBODIMENTS

As below, embodiments for implementing the present disclosure will be described with reference to the drawings. In the respective drawings, dimensions and scales of the respective parts are made different from real ones as appropriate. The embodiments to be described are preferred specific examples of the present disclosure and various technically preferable limitations are imposed thereon. However, the scope of the present disclosure is not limited to these embodiments unless the present disclosure is particularly limited in the following description.

### A. Embodiment

In this embodiment, a management system Sys that manages cartridges 7 storing ink used in a printing apparatus 5 is explained as an example. In the embodiment, the printing apparatus 5 is an example of “electronic apparatus”.

### 1. Configuration of Management System

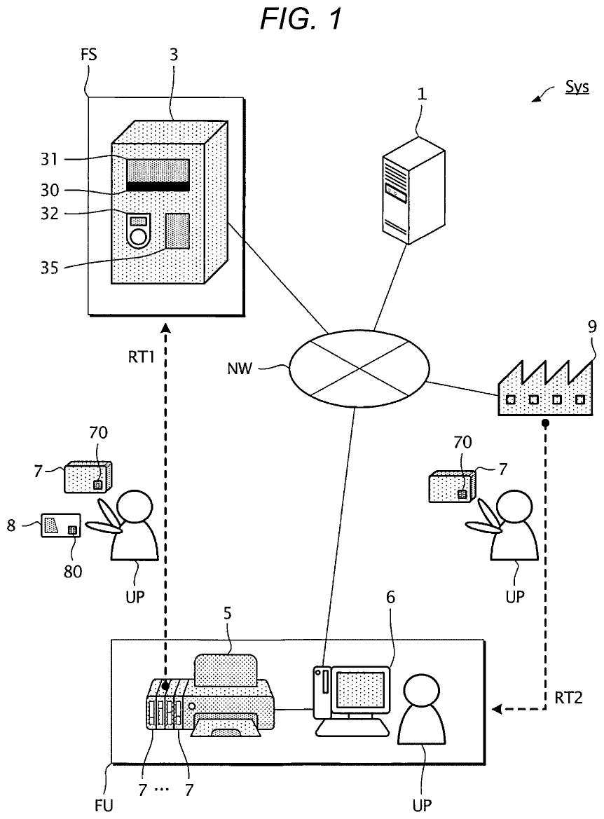

As below, an example of a configuration of the management system Sys according to the embodiment will be explained with reference to FIGS. 1 to 8.

FIG. 1 is a block diagram showing the example of the configuration of the management system Sys.

As shown in FIG. 1, the management system Sys includes a management server 1, one or more recycling boxes 3 communicable with the management server 1 via a network NW, one or more printing apparatuses 5 communicable with the management server 1 via the network NW, one or more terminal apparatuses 6 provided to correspond to the one or more printing apparatuses 5, and a recycling factory 9 communicable with the management server 1 via the network NW, and manages the cartridges 7 storing the ink used in the printing apparatus 5.

The management server 1 is a server apparatus for managing the management system Sys.

The cartridge 7 is a container storing ink used in the printing apparatus 5, which can be attached to the printing apparatus 5.

In the embodiment, the cartridge 7 is an example of “specific component”.

The recycling box 3 is equipment for collecting a used cartridge 7 from a user UP of the printing apparatus 5. Here, the used cartridge 7 is, for example, the cartridge 7 in which a residual amount of the ink stored therein is small or the cartridge 7 in which the ink stored therein is deteriorated. That is, in the embodiment, even when the ink remains inside the cartridge 7, the recycling box 3 can collect the cartridge 7.

In the embodiment, the recycling box 3 is installed in a commercial facility FS. Here, the commercial facility FS is a commercial facility such as an electronics retail store selling the printing apparatus 5 or a shopping mall selling various commodities, a public facility such as a public hall, a medical facility such as a hospital, or the like.

Note that, in the embodiment, a case where the user UP brings the used cartridge 7 to the recycling box 3 for collection of the used cartridge 7 is assumed as an example, however, the present disclosure is not limited to the case. For example, the user UP may send the used cartridge 7 by mail to the recycling factory 9 for collection of the used cartridge 7.

The recycling factory 9 is a facility for recycling the used cartridge 7 as a recycled product of the cartridge 7 by recycling the used cartridge 7 collected from the user UP in the recycling box 3. Specifically, the recycling factory 9 is a facility for manufacturing a recycled product of the cartridge 7 by cleansing the used cartridge 7 and refilling the cleansed cartridge 7 with ink as a recycled used cartridge 7. Hereinafter, the recycled product of the cartridge 7 may be referred to as “recycled cartridge 7X”.

In the embodiment, a case where the recycling factory 9 can decompose the used cartridge 7 into materials and manufacture the recycled cartridge 7X using the decomposed materials is assumed. Further, in the embodiment, a case where the recycling factory 9 can decompose the used cartridge 7 into materials and manufacture a product different from the recycled cartridge 7X as a recycled product using the decomposed materials is assumed.

Hereinafter, manufacturing of the recycled cartridge 7X using the used cartridge 7 is referred to as “refilling”. Further, hereinafter, decomposing of the used cartridge 7 into materials and manufacturing of the recycled cartridge 7x or a product different from the recycled cartridge 7X is referred to as “material recycling”.

In the embodiment, a case where the printing apparatus 5 is provided in a user facility FU is assumed as an example. Here, the user facility FU is a facility where the user UP uses the printing apparatus 5 including a home of the user UP and an office of the user UP.

That is, in the embodiment, a case where the used cartridge 7 used in the printing apparatus 5 provided in the user facility FU is collected through a cartridge collection route RT1 from the user facility FU to the recycling box 3. Note that, in the embodiment, for collection of the used cartridge 7 through the cartridge collection route RT1, a case where the user UP is authenticated with a user card 8 possessed by the user UP when dropping the used cartridge 7 in the recycling box 3 is assumed as an example.

Further, in the embodiment, a case where the used cartridge 7 collected through the cartridge collection route RT1 is recycled as the recycled cartridge 7X in the recycling factory 9 and delivered through a cartridge delivery route RT2 from the recycling factory 9 to the user facility FU is assumed.

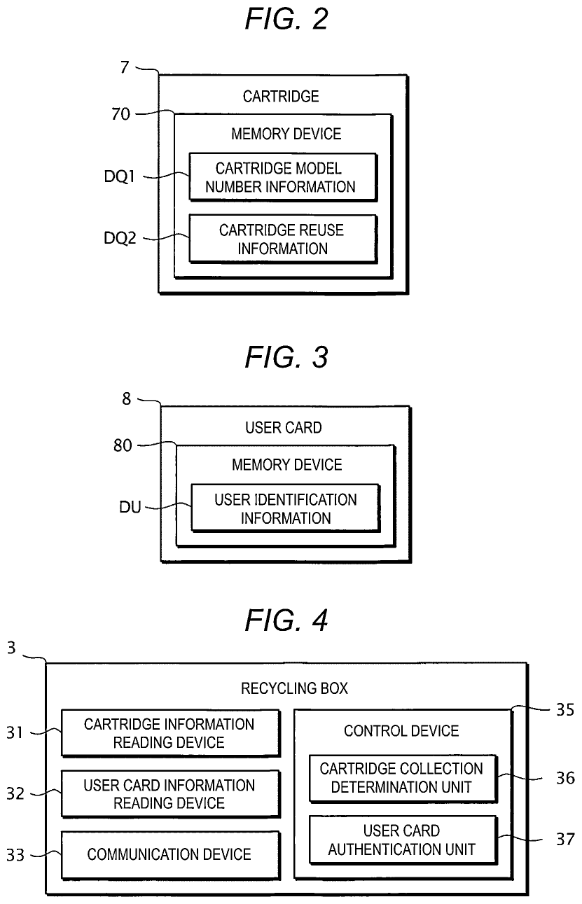

FIG. 2 is a block diagram showing an example of a configuration of the cartridge 7.

As shown in FIG. 2, the cartridge 7 includes a memory device 70. The cartridge 7 is provided with an ink storage chamber (not shown) that stores ink.

The memory device 70 is, for example, an IC chip, and stores cartridge model number information DQ1 and cartridge reuse information DQ2.

The cartridge model number information DQ1 is information indicating a product model number of the cartridge 7.

The cartridge reuse information DQ2 indicates a reuse count AQ. Here, the reuse count AQ is the number of times of recycling of the cartridge 7 as a recycled product. Specifically, the reuse count AQ is set to “0” when the cartridge 7 is a brand-new product (new article) before recycling, and is set to a numerical value “1” or more when the cartridge 7 is a recycled product.

FIG. 3 is a block diagram showing an example of a configuration of the user card 8.

As shown in FIG. 3, the user card 8 includes a memory device 80. The memory device 80 is, for example, an IC chip, and stores user identification information DU.

The user identification information DU is information indicating a user ID for uniquely identifying each user of a plurality of users possessing the user cards 8. In the embodiment, a case where a user possessing the user card 8 is the user UP using the printing apparatus 5 is assumed. However, the present disclosure is not limited to the case. The user possessing the user card 8 may be the user UP using the printing apparatus 5 and the user using the commercial facility FS. The user possessing the user card 8 may be a user using the cartridge 7.

FIG. 4 is a block diagram showing an example of a configuration of the recycling box 3.

As shown in FIGS. 1 and 4, the recycling box 3 includes a cartridge slot 30, a cartridge information reading device 31, a user card information reading device 32, a communication device 33, and a control device 35.

The cartridge slot 30 is an opening for the user UP to drop the cartridge 7 into a cartridge storage space (not shown) provided inside the recycling box 3.

When the cartridge 7 is dropped into the cartridge slot 30, the cartridge information reading device 31 reads the cartridge model number information DQ1 and the cartridge reuse information DQ2 stored in the memory device 70 from the memory device 70 provided in the cartridge 7. However, the present disclosure is not limited to the case. When the cartridge 7 is dropped into the cartridge slot 30, the cartridge information reading device 31 may read at least the cartridge model number information DQ1 stored in the memory device 70 from the memory device 70 provided in the cartridge 7.

When the user UP touches the user card information reading device 32 with the user card 8, the user card information reading device 32 reads the user identification information DU stored in the memory device 80 from the memory device 80 provided in the user card 8.

The communication device 33 is hardware for communicating with an external device present outside the recycling box 3 via a network NW such as a wired network and a wireless network.

The control device 35 includes a cartridge collection determination unit 36 and a user card authentication unit 37.

The cartridge collection determination unit 36 determines whether an object dropped through the cartridge slot 30 corresponds to the cartridge 7 collectable by the recycling box 3 based on a reading result by the cartridge information reading device 31. Specifically, the cartridge collection determination unit 36 determines whether a model number indicated by the cartridge model number information DQ1 read by the cartridge information reading device 31 is a model number corresponding to the cartridge 7 collectable by the recycling box 3.

When the model number indicated by the cartridge model number information DQ1 read by the cartridge information reading device 31 is the model number corresponding to the cartridge 7 collectable by the recycling box 3, the cartridge collection determination unit 36 determines that the object dropped through the cartridge slot 30 corresponds to the cartridge 7 collectable by the recycling box 3. When the model number indicated by the cartridge model number information DQ1 read by the cartridge information reading device 31 is not the model number corresponding to the cartridge 7 collectable by the recycling box 3, the cartridge collection determination unit 36 determines that the object dropped through the cartridge slot 30 does not correspond to the cartridge 7 that can be collected by the recycling box 3. When the cartridge information reading device 31 fails to read the cartridge model number information DQ1, the cartridge collection determination unit 36 determines that the object dropped through the cartridge slot 30 does not correspond to the cartridge 7 collectable by the recycling box 3.

When a result of the determination by the cartridge collection determination unit 36 is positive, that is, when the object dropped through the cartridge slot 30 corresponds to the cartridge 7 collectable by the recycling box 3, the recycling box 3 stores the cartridge 7 in the cartridge storage space in the recycling box 3. Then, the cartridge 7 stored in the cartridge storage space in the recycling box 3 is periodically collected and transferred to the recycling factory 9.

On the other hand, when the result of the determination by the cartridge collection determination unit 36 is negative, that is, when the object dropped through the cartridge slot 30 does not correspond to the cartridge 7 collectable by the recycling box 3, the recycling box 3 ejects the object to the outside of the recycling box 3.

When the user card information reading device 32 is touched by the user card 8, the user card authentication unit 37 identifies the user ID of the user UP possessing the user card 8 based on the user identification information DU stored in the memory device 80 of the user card 8. The user card authentication unit 37 notifies the management server 1 of the identified user ID via the network NW.

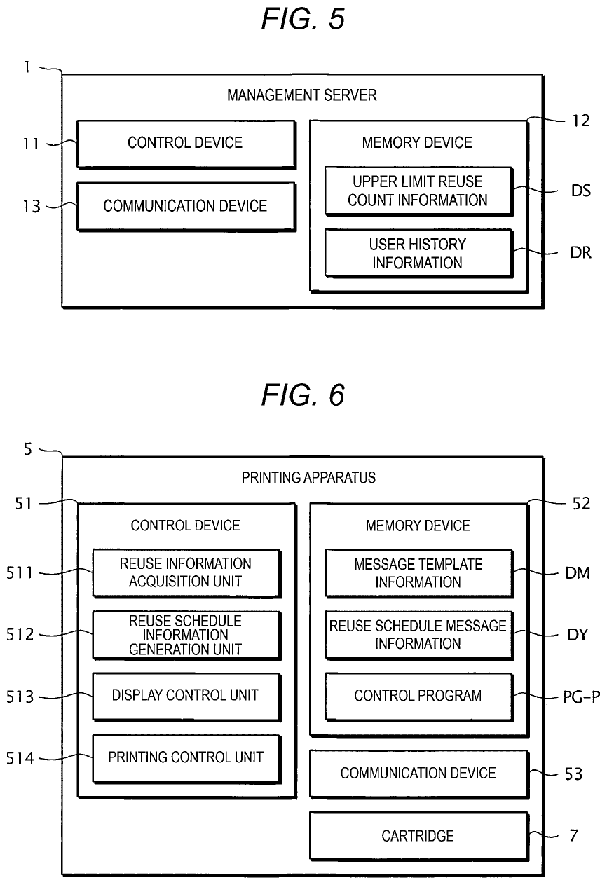

FIG. 5 is a block diagram showing an example of a configuration of the management server 1.

As shown in FIG. 5, the management server includes a control device 11, a memory device 12, and a communication device 13.

The control device 11 is hardware such as a CPU (Central Processing Unit) that controls the respective parts of the management server 1.

The communication device 13 is hardware for communicating with an external device present outside the management server 1 via the network NW.

The memory device 12 includes a volatile memory such as a RAM (Random Access Memory) that functions as a work area of the control device 11 and a nonvolatile memory such as an EEPROM (Electrically Erasable Programmable Read-Only Memory) that stores various information. In the embodiment, the memory device 12 stores upper limit reuse count information DS and user history information DR.

The upper limit reuse count information DS indicates an upper limit reuse count AS. Here, the upper limit reuse count AS is an upper limit value of the number of times of refilling that can be performed on the cartridge 7. That is, in the embodiment, a case where the cartridge 7 can be refilled at “AS times” is assumed. In other words, in the embodiment, a case where, with respect to a used cartridge 7 refilled at “AS times” or less in the past, the recycling factory 9 performs refilling to manufacture a recycled cartridge 7X using the used cartridge 7, however, with respect to a used cartridge 7 refilled at “AS times” in the past, performs material recycling of decomposing the used cartridge 7 into materials and reusing is assumed.

In the embodiment, the upper limit reuse count AS is an example of “reference value”.

The user history information DR indicates a cumulative number of uses of recycled products AR. Here, the cumulative number of uses of recycled products AR is the number of the recycled cartridges 7X used by the user UP to the present. In the embodiment, the number of times when the user UP purchases the recycled cartridge 7X is referred to as the cumulative number of uses of recycled products AR.

In the embodiment, the management server 1 communicates with the recycling box 3 via the network NW, and thereby, manages a collection status of the used cartridge 7 in the recycling box 3. Further, in the embodiment, the management server 1 communicates with the recycling factory 9 via the network NW, and thereby, manages a purchase status of the recycled cartridge 7X by the user UP.

FIG. 6 is a block diagram showing an example of a configuration of the printing apparatus 5.

As shown in FIG. 6, the printing apparatus 5 includes a control device 51, a memory device 52, a communication device 53, and one or more cartridges 7.

The cartridge 7 provided in the printing apparatus 5 is a brand-new cartridge 7 or a recycled cartridge 7X. That is, of the one or more cartridges 7 provided in the printing apparatus 5, part or all may be the recycled cartridges 7X, all may be the recycled cartridges 7X, or all may be new cartridges 7.

The communication device 53 is hardware for communicating with terminal the apparatus 6 and communicating with an external device existing outside the management server 1 via the network NW.

The memory device 52 includes a volatile memory such as a RAM that functions as a work area of the control device 51, and a non-volatile memory such as an EEPROM that stores various types of information. In the embodiment, the memory device 52 stores message template information DM, reuse schedule message information DY, and a control program PG-P of the printing apparatus 5.

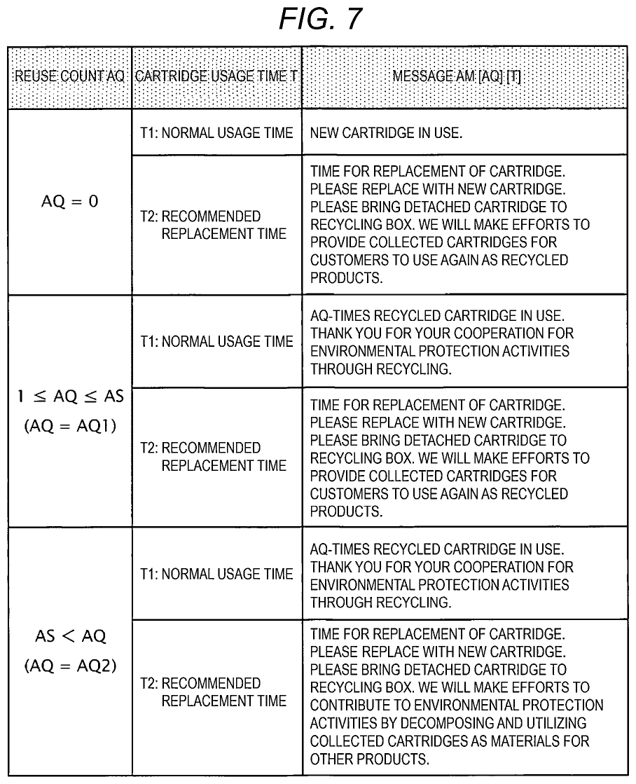

FIG. 7 is an explanatory diagram showing an example of a data configuration of the message template information DM.

As shown in FIG. 7, the message template information DM is information indicating a message AM as a candidate for a message for notification to the user UP. In the embodiment, a case where a plurality of messages AM are provided according to a combination of the reuse count AQ indicated by the cartridge reuse information DQ2 and a cartridge usage time T. Hereinafter, the message AM when the reuse count is “AQ” and the cartridge usage time is “T” is referred to as “message AM[AQ][T]”. The cartridge usage time T is a time from when the cartridge 7 is attached to the printing apparatus 5 to the present.

In the embodiment, when the cartridge use time T is equal to or shorter than a threshold time Tth, the printing apparatus 5 can execute printing processing of forming an image on a medium using the ink filled in the cartridge 7. Hereinafter, the cartridge usage time T equal to or shorter than the threshold time Tth is referred to as “normal usage time T1”.

In the embodiment, when the cartridge usage time T is longer than the threshold time Tth, the printing apparatus 5 may not execute the printing processing using the ink filled in the cartridge 7 and replacement of the cartridge 7 is recommended for execution of the printing processing by the printing apparatus 5. Hereinafter, the cartridge usage time T longer than the threshold time Tth is referred to as “recommended replacement time T2”. In the embodiment, the time when the cartridge usage time T becomes the recommended replacement time T2 is an example of the “replacement time”.

In the embodiment, a message AM[0][T1] is a message indicating that the cartridge 7 attached to the printing apparatus 5 is a brand-new product (new article) cartridge 7. Specifically, in the embodiment, a case where the message AM[0][T1] is a message “BRAND-NEW CARTRIDGE IN USE” is assumed as an example.

The message AM[0][T1] is a message for notification to the user UP when the reuse count AQ is “0” and the cartridge usage time T is the normal usage time T1. In other words, the message AM[0][T1] is a message for notification to the user UP when the cartridge 7 attached to the printing apparatus 5 is a brand-new cartridge 7 and the printing processing can be executed without replacement of the cartridge 7.

In the embodiment, a message AM[0][T2] is a message indicating that the cartridge 7 attached to the printing apparatus 5 is at the replacement time and that the cartridge 7 is collected and refilled and reused as a recycled cartridge 7X. Specifically, in the embodiment, as an example, a case where the message AM[0][T2] is a message “TIME FOR REPLACEMENT OF CARTRIDGE. PLEASE REPLACE WITH NEW CARTRIDGE. PLEASE BRING DETACHED CARTRIDGE TO RECYCLING BOX. WE WILL MAKE EFFORTS TO PROVIDE COLLECTED CARTRIDGES FOR CUSTOMERS TO USE AGAIN AS RECYCLED PRODUCTS.” is assumed.

The message AM[0][T2] is a message for notification to the user UP when the reuse count AQ is “0” and the cartridge usage time T is the recommended replacement time T2. That is, the message AM[0][T2] is a message for notification to the user UP when the cartridge 7 attached to the printing apparatus 5 is a brand-new cartridge 7 and it is highly possible that the execution of the printing processing is difficult without replacement of the cartridge 7.

Further, in the embodiment, the message AM[AQ1][T1] is a message indicating that the cartridge 7 attached to the printing apparatus 5 is a recycled cartridge 7X reused at the AQ times and that the user UP contributes to environmental protection by using the recycled cartridge 7X. Specifically, in the embodiment, as an example, a case where a message AM[AQ1][T1] is a message “AQ-TIMES RECYCLED CARTRIDGE IN USE. THANK YOU FOR YOUR COOPERATION FOR ENVIRONMENTAL PROTECTION ACTIVITIES THROUGH RECYCLING” is assumed.

The message AM[AQ1][T1] is a message for notification to the user UP when the reuse count AQ is “AQ1” and the cartridge usage time T is the normal usage time T1. The reuse count AQ1 is a natural number satisfying “1≤AQ1≤AS”. That is, the message AM[AQ1][T1] is a message for notification to the user UP when the cartridge 7 attached to the printing apparatus 5 is a recycled cartridge 7X reused at “AQ times (=AQ1 times)” and the printing processing can be executed without replacement of the cartridge 7.

In the embodiment, the message AM[AQ1][T2] is a message indicating that the recycled cartridge 7X attached to the printing apparatus 5 is at the replacement time and that the recycled cartridge 7X is collected and refilled and reused as a recycled cartridge 7X. Specifically, in the embodiment, as an example, a case where the message AM[AQ1][T2] is a message “TIME FOR REPLACEMENT OF CARTRIDGE. PLEASE REPLACE WITH NEW CARTRIDGE. PLEASE BRING DETACHED CARTRIDGE TO RECYCLING BOX. WE WILL MAKE EFFORTS TO PROVIDE COLLECTED CARTRIDGES FOR CUSTOMERS TO USE AGAIN AS RECYCLED PRODUCTS.” is assumed.

The message AM[AQ1][T2] is a message for notification to the user UP when the reuse count AQ is “AQ1” and the cartridge usage time T is the recommended replacement time T2. That is, the message AM[AQ1][T2] is a message for notification to the user UP when the cartridge 7 attached to the printing apparatus 5 is a recycled cartridge 7X reused at “AQ times (=AQ1 times)” and it is highly possible that the execution of the printing processing is difficult without replacing the cartridge 7.

Further, in the embodiment, the message AM[AQ2][T1] is a message indicating that the cartridge 7 attached to the printing apparatus 5 is the recycled cartridge 7X reused at the AQ times and that the user UP contributes to environmental protection by using the recycled cartridge 7X. Specifically, in the embodiment, as an example, a case where the message AM[AQ2][T1] is a message “AQ-TIMES RECYCLED CARTRIDGE IN USE. THANK YOU FOR YOUR COOPERATION FOR ENVIRONMENTAL PROTECTION ACTIVITIES THROUGH RECYCLING” is assumed.

The message AM[AQ2][T1] is a message for notification to the user UP when the reuse count AQ is “AQ2” and the cartridge usage time T is the normal usage time T1. The reuse count AQ2 is a natural number satisfying “AQ2>AS”. More specifically, the reuse count AQ2 is a natural number satisfying “AQ2=1+AS”. That is, the message AM[AQ2][T1] is a message for notification to the user UP when the cartridge 7 attached to the printing apparatus 5 is a recycled cartridge 7X reused at “AQ times (=AQ2 times)” and the printing processing can be executed without replacement of the cartridge 7.

Further, in the embodiment, the message AM[AQ2][T2] is a message indicating that the recycled cartridge 7X attached to the printing apparatus 5 is at the replacement time and that the recycled cartridge 7X is collected and decomposed into materials for material recycling and reused. Specifically, in the embodiment, as an example, a case where the message AM[AQ2][T2] is a message “TIME FOR REPLACEMENT OF CARTRIDGE. PLEASE REPLACE WITH NEW CARTRIDGE. PLEASE BRING DETACHED CARTRIDGE TO RECYCLING BOX. WE WILL MAKE EFFORTS TO CONTRIBUTE TO ENVIRONMENTAL PROTECTION ACTIVITIES BY DECOMPOSING AND UTILIZING COLLECTED CARTRIDGES AS MATERIALS FOR OTHER PRODUCTS” is assumed.

The message AM[AQ2][T2] is a message for notification to the user UP when the reuse count AQ is “AQ2” and the cartridge usage time T is the recommended replacement time T2. That is, the message AM[AQ2][T2] is a message for notification to the user UP when the cartridge 7 attached to the printing apparatus 5 is a recycled cartridge 7X reused at “AQ times (=AQ2 times)” and it is highly possible that the execution of the printing processing is difficult without replacement of the cartridge 7.

The reuse schedule message information DY is information indicating the reuse schedule message AY for notification to the user UP. In the embodiment, a case where the reuse schedule message AY varies according to the reuse count AQ indicated by the cartridge reuse information DQ2 and the cartridge usage time T is assumed. Specifically, when the reuse count is “AQ” and the cartridge usage time is “T”, the reuse schedule message AY is the message AM[AQ][T].

The control device 51 includes a processor. The processor of the control device 51 includes, for example, one or more CPUs. In the embodiment, the processor of the control device 51 executes the control program PG-P stored in the memory device 52 and operates according to the control program PG-P, and thereby, may function as a reuse information acquisition unit 511, a reuse schedule information generation unit 512, a display control unit 513, and a printing control unit 514. The processor of the control device 51 may include hardware such as a GPU (Graphics Processing Unit), a DSP (Digital Signal Processor), or an FPGA (Field Programmable Gate Array) in addition to the one or more CPUs or instead of part or all of the one or more CPUs. In this case, part or all of functions implemented by the processor of the control device 51 may be implemented by the hardware such as a DSP.

The reuse information acquisition unit 511 acquires the cartridge reuse information DQ2 from the memory device 70 of the cartridge 7 provided in the printing apparatus 5. In the embodiment, the reuse information acquisition unit 511 is an example of “acquisition unit”, and the cartridge reuse information DQ2 is an example of “reuse information”.

The reuse schedule information generation unit 512 generates the reuse schedule message information DY based on the cartridge reuse information DQ2, the upper limit reuse count information DS, and the message template information DM. In the embodiment, the reuse schedule information generation unit 512 is an example of “generation unit”, and the reuse schedule message information DY is an example of “reuse schedule information”.

The display control unit 513 controls the display device 63 of the terminal apparatus 6, which will be described later, to display the reuse schedule message AY indicated by the reuse schedule message information DY.

The printing control unit 514 executes printing processing of forming an image on a medium by controlling a print head (not shown) provided in the printing apparatus.

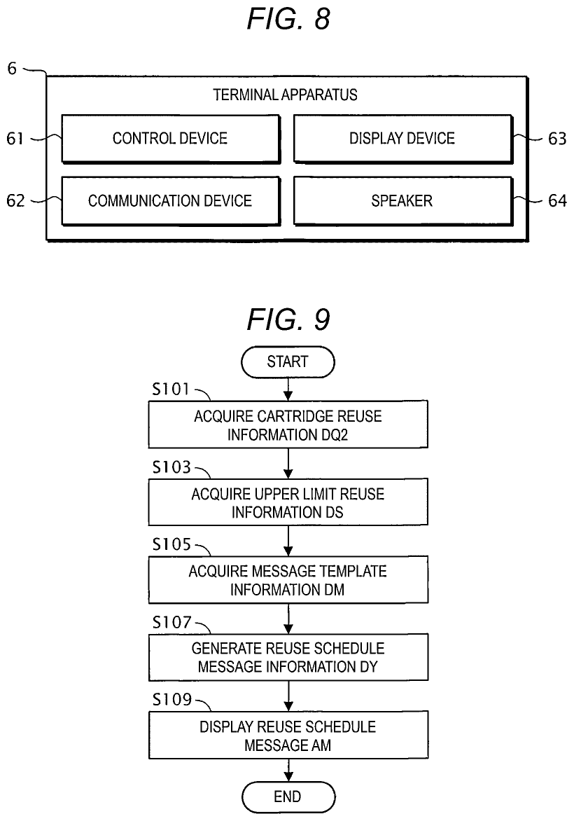

FIG. 8 is a block diagram showing an example of a configuration of the terminal apparatus 6.

As shown in FIG. 8, the terminal apparatus includes a control device 61, a communication device 62, a display device 63, and a speaker 64.

The control device 61 is hardware such as a CPU that controls the respective parts of the terminal apparatus 6.

The communication device 62 is hardware for communicating with an external device present outside the terminal apparatus 6 via the network NW or the like.

The display device 63 is hardware for displaying an image under control of the control device 61. In the embodiment, the display device 63 is an example of “display unit”.

The speaker 64 is hardware for generating sound under control of the control device 61.

When the reuse schedule message information DY is supplied from the printing apparatus 5, the control device 61 controls the display device 63 to display the reuse schedule message AY and controls the speaker 64 to emit the reuse schedule message AY. However, the present disclosure is not limited to the case. When the reuse schedule message information DY is supplied from the printing apparatus 5, the control device 61 may control the display device 63 and the speaker 64 to execute one of display of the reuse schedule message AY in the display device 63 and emission of the reuse schedule message AY by the speaker 64.

### 2. Reuse Schedule Presentation Processing

As below, an example of the reuse schedule presentation processing will be described with reference to FIG. 9.

FIG. 9 is a flowchart showing an example of the operation of the control device 51 when the control device 51 performs the reuse schedule presentation processing. The reuse schedule presentation processing is processing of presenting the reuse schedule message AY to the user UP by the printing apparatus 5. In the embodiment, as an example, a case where the reuse schedule presentation processing is executed when the power of the printing apparatus 5 is turned on, when the cartridge 7 is attached to the printing apparatus 5, and when the printing processing is executed in the printing apparatus 5 is assumed.

As shown in FIG. 9, in the reuse schedule presentation processing, the reuse information acquisition unit 511 acquires the cartridge reuse information DQ2 from the cartridge 7 (S101).

Then, the reuse schedule information generation unit 512 acquires the upper limit reuse count information DS from the management server 1 via the terminal apparatus 6 (S103).

The reuse schedule information generation unit 512 acquires the message template information DM from the memory device 52 (S105).

Then, the reuse schedule information generation unit 512 generates the reuse schedule message information DY based on the cartridge reuse information DQ2, the upper limit reuse count information DS, and the message template information DM acquired at steps S101 to S105 (S107).

Then, the display control unit 513 supplies the reuse schedule message information DY generated at step S107 to the terminal apparatus 6, and thereby, controls the terminal apparatus 6 to display the reuse schedule message AY on the display device 63 provided in the terminal apparatus 6 and emit the reuse schedule message AY from the speaker 64 provided in the terminal apparatus 6 (S109), and the reuse schedule presentation processing is ended.

### 3. Conclusion of Embodiment

As described above, the printing apparatus 5 according to the embodiment is the printing apparatus 5 including the replaceable cartridge 7, including the reuse information acquisition unit 511 acquiring the cartridge reuse information DQ2 related to the reuse history of the cartridge 7, the reuse schedule information generation unit 512 generating the reuse schedule message information DY indicating the reuse schedule message AY related to the future reuse mode of the cartridge 7 based on the cartridge reuse information DQ2, and the display control unit 513 controlling the display device 63 to display the reuse schedule message AY related to the future reuse mode of the cartridge 7 based on the reuse schedule message information DY.

As described above, according to the embodiment, the user UP of the printing apparatus 5 is motivated to reuse the cartridge 7 by displaying the future reuse mode of the cartridge 7. Therefore, according to the embodiment, the user UP can be enlightened to reuse the cartridge 7 more strongly in comparison with a configuration without display of the future reuse mode of the cartridge 7. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

Further, in the embodiment, the reuse schedule message information DY is information indicating whether the recycled cartridge 7X can be manufactured using the cartridge 7, or whether the cartridge 7 can be decomposed into the materials and reused.

That is, according to the embodiment, the user UP of the printing apparatus 5 is motivated to reuse the cartridge 7 by specific display as to whether the future reuse mode of the cartridge 7 is refilling or material recycling. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

Furthermore, in the embodiment, the display control unit 513 controls the display device 63 to display the reuse schedule message AY related to the future reuse mode of the cartridge 7 at the replacement time of the cartridge 7.

That is, according to the embodiment, at the replacement time of the cartridge 7, the user UP of the printing apparatus 5 is motivated to reuse the cartridge 7 by display of the future reuse mode of the cartridge 7. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

In the embodiment, the display control unit 513 controls the display device 63 to display whether the cartridge 7 is a recycled product of the cartridge 7 manufactured in the past using the used cartridge 7.

That is, according to the embodiment, the user UP of the printing apparatus 5 is motivated to reuse the cartridge 7 by display as to whether the cartridge 7 is a recycled product of the cartridge 7 reused in the past. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display as to whether the cartridge 7 is a recycled product of the cartridge 7 reused in the past.

Further, in the embodiment, the display control unit 513 controls the display device 63 to display that the contribution to the environmental protection is made with the use of the cartridge 7 when the cartridge 7 is a recycled product of the cartridge 7 manufactured in the past using the used cartridge 7.

That is, according to the embodiment, the user UP of the printing apparatus 5 is motivated to reuse the cartridge 7 by display of the environmental protection made with the reuse of the cartridge 7. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the environmental protection made with the reuse of the cartridge 7.

Furthermore, in the embodiment, when the reuse count AQ of the cartridge 7 indicated by the cartridge reuse information DQ2 is equal to or smaller than the upper limit reuse count AS, the reuse schedule information generation unit 512 generates the reuse schedule message information DY indicating that a recycled cartridge 7X can be manufactured using the cartridge 7.

That is, according to the embodiment, the user UP of the printing apparatus 5 is motivated to reuse the cartridge 7 by specific display of the future reuse mode of the cartridge 7 as refilling. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

Further, in the embodiment, when the reuse count AQ of the cartridge 7 indicated by the cartridge reuse information DQ2 is larger than the upper limit reuse count AS, the reuse schedule information generation unit 512 generates the reuse schedule message information DY indicating that the cartridge 7 can be decomposed into materials and reused.

That is, according to the embodiment, the user UP of the printing apparatus 5 is motivated to reuse the cartridge 7 by specific display of the future reuse mode of the cartridge 7 as material recycling. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

Furthermore, in the embodiment, the display control unit 513 controls the display device 63 to display the reuse count AQ as the number of times at which the cartridge 7 is manufactured as the recycled cartridge 7X in the past.

That is, according to the embodiment, the user UP of the printing apparatus 5 is motivated to reuse the cartridge 7 by display of the reuse count AQ as the number of reuses of the cartridge 7 in the past. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the number of reuses of the cartridge 7 in the past.

### B. Modified Examples

The above described respective embodiments can be variously modified. Configurations s of specific modifications will be exemplified as below. Two or more configurations optionally selected from the following exemplifications can be combined as appropriate as long as the configurations are mutually consistent. In the modifications exemplified below, elements having the same actions and functions as those of the embodiment have the same signs referred to in the above description, and the detailed description of the respective elements will be omitted as appropriate.

### Modified Example 1

In the above described embodiment, the case where the reuse schedule presentation processing is executed when the power of the printing apparatus 5 is turned on, when the cartridge 7 is attached to the printing apparatus 5, and when the printing processing is executed in the printing apparatus 5 is exemplified, however, the present disclosure is not limited to the configuration. The reuse schedule presentation processing may be executed, for example, when the cartridge 7 is detached from the printing apparatus 5. In this case, the control device 51 may control the memory device 52 to store the cartridge reuse information DQ2 acquired from the cartridge 7 before being detached from the printing apparatus 5.

That is, in the modified example, when the cartridge 7 is detached from the printing apparatus 5, the display control unit 513 controls the display device 63 to display the reuse schedule message AY relating to the future reuse mode of the cartridge 7.

Therefore, according to the modified example, when the cartridge 7 is detached from the printing apparatus 5, the user UP of the printing apparatus 5 is motivated to reuse the cartridge 7 by display of the future reuse mode of the cartridge 7. Thus, according to the embodiment, the greater contribution to “improve education, awareness-raising and human and institutional capacity on climate change mitigation, adaptation, impact reduction and early warning” described in Target 13.3 of the SDGs may be made in comparison with a configuration without display of the future reuse mode of the cartridge 7.

### Modified Example 2

In the above described embodiment and modified example 1, the configuration in which the terminal apparatus 6 includes the display device 63 and the speaker 64 is described as an example, however, the present disclosure is not limited to the configuration. For example, the display device 63 may be provided in the printing apparatus 5. The speaker 64 may be provided in the printing apparatus 5.

### Modified Example 3

In the above described embodiment and the modified examples 1 and 2, the cartridge 7 provided in the printing apparatus 5 is described as an example as an object of management of the management system Sys, however, the present disclosure is not limited to the configuration. The object of management of the management system Sys may be any replaceable specific component provided in the electronic apparatus.

Here, the specific component may be, for example, not only the cartridge 7 that stores the ink as a consumable item but also a storage container that stores a consumable item used in the printing apparatus 5 such as a toner bottle that stores toner as a consumable item. The specific component may be, for example, a storage container that stores a waste produced with the use of the printing apparatus 5 such as a waste ink box that stores waste ink as a waste or a waste toner box that stores waste toner as a waste.

Furthermore, the specific component is not limited to a component related to the printing apparatus 5. For example, the specific component may be a replaceable component provided in an electronic apparatus such as a lamp provided in a projector and a battery provided in a smartphone.

What is claimed is:

1. An electronic apparatus including a replaceable specific component, comprising:
an acquisition unit acquiring reuse information related to a reuse history of the specific component;
a generation unit generating reuse schedule information indicating a future reuse mode of the specific component based on the reuse information; and
a display control unit controlling a display unit to display the future reuse mode of the specific component based on the reuse schedule information.

2. The electronic apparatus according to claim 1, wherein
the reuse schedule information is information indicating whether a recycled product of the specific component can be manufactured using the specific component, or whether the specific component can be decomposed into materials and reused.

3. The electronic apparatus according to claim 1, wherein
the display control unit controls the display unit to display the future reuse mode of the specific component at a replacement time of the specific component and when the specific component is detached from the electronic apparatus.

4. The electronic apparatus according to claim 1, wherein the display control unit controls the display unit to display whether the specific component is a recycled product of the specific component manufactured in the past using the specific component.

5. The electronic apparatus according to claim 4, wherein
the display control unit controls the display unit to display that a contribution to environmental protection is made with use of the specific component when the specific component is a recycled product of the specific component manufactured in the past using the specific component.

6. The electronic apparatus according to claim 2, wherein
the generation unit generates the reuse schedule information indicating that a recycled product of the specific component can be manufactured using the specific component when a number of reuses of the specific component indicated by the reuse information is equal to or less than a reference value.

7. The electronic apparatus according to claim 6, wherein
the generation unit generates the reuse schedule information indicating that the specific component can be decomposed into materials and reused when the number of reuses of the specific component indicated by the reuse information is larger than the reference value.

8. The electronic apparatus according to claim 1, wherein
the display control unit controls the display unit to display a number of times at which the specific component is manufactured as a recycled product of the specific component in the past.
